(19) United States
(12) Patent Application Publication
(10) Pub. No.: US 2011/0113635 A1
(43) Pub. Date: May 19, 2011

(54) PRUNING LOPPER WITH AN ADJUSTABLE ATTACHMENT MECHANISM

(75) Inventors: Hyok Lee, Corona, CA (US); Timothy Edward Atnip, Temecula, CA (US); Kevin Wong, Mukilteo, WA (US)

(73) Assignee: Corona Clipper, Inc., Corona, CA (US)

(21) Appl. No.: 12/621,447

(22) Filed: Nov. 18, 2009

(51) Int. Cl. B26B 13/00

(52) U.S. Cl. 30/194; 30/165

(57) ABSTRACT

A pruning lopper with an adjustable attachment mechanism to provide for versatile cuts of tree branches and shrubs. The attachment mechanism is a ball joint that can rotate in an x-direction, a y-direction, around the axis of rotation of the pole, or any combination of the three. A pulley system internal to the pole prevents entanglement with tree branches while in operation.

### BACKGROUND OF THE INVENTION

1. Field of the Invention

The present invention relates generally to improvements in pruning loppers and more particularly pertains to pruning loppers with adjustable lopping heads.

2. Description of Related Art

Those concerned with the development of pruning loppers have long recognized the need for a versatile, reliable, and powerful pruning lopper. It has been the practice to employ pruning loppers with external pulley systems and fixed lopping heads. However, when operating these systems, a user must manage the cord associated with the external pulley system and must avoid fouling the pulley system with debris from the tree branches and shrubs being cut. In addition, the user must stand at a variety of, sometimes, difficult positions to administer precise cuts on tree branches and shrubs.

### SUMMARY OF THE INVENTION

The present invention provides a pruning lopper with a lopping head that is attached to the pruning pole by a selectively adjustable mechanism for manipulating the lopping head. A pulley system is located inside the pruning pole, thereby avoiding cord interference with nearby tree branches and shrubs. The adjustable attachment mechanism allows a user to adjust the portion of the lopping head with respect to the pole, to cut tree branches and shrubs from a single standing position or a variety of comfortable standing positions. This provides an improvement over prior art lopper heads, where a user must move the entire pole at odd angles, or stand in an uncomfortable position to apply a desired cut to a tree branch or a shrub. The attachment mechanism allows the lopping head to be positioned in a great variety of positions relative to the position of the pole.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is a perspective view of the preferred embodiment of the invention;

FIG. 2 is a perspective view of the preferred embodiment in operation;

FIG. 3 is a perspective view of the preferred embodiment in operation;

FIG. 4 is a perspective view of the lopping head;

FIG. 5 is a perspective view of the lopping head of FIG. 4 in operation;

FIG. 6 is a cut away view of the pole, displaying the internal pulley system;

FIG. 7 is a perspective view of the internal pulley system;

FIG. 8 is a perspective view of the attachment mechanism and lopping head;

FIG. 9 is a perspective view of the attachment mechanism and lopping head;

FIG. 10 is a perspective view and partially broken away section of the attachment mechanism;

FIG. 11 is a perspective view of an alternate embodiment of the present invention using an extendable pole;

FIG. 12 is a perspective view of the embodiment of FIG. 10 in operation;

FIG. 13 is a perspective view of a section of the pole of FIG. 10, with a detailed view of a section of the pole;

FIG. 14 is a perspective view of a section of the pole of FIG. 10, showing a part of the internal pulley system and extension mechanism; and

FIG. 15 is a perspective view of a section of the pole of FIG. 10, showing the extension mechanism.

### DETAILED DESCRIPTION OF THE PREFERRED EMBODIMENTS

The present invention utilizes a pole with two ends, with a lopping head located at one end of the pole. An attachment mechanism attaches the lopping head to the pole. In the preferred embodiment, the attachment mechanism is a ball joint that can rotate about the axis of the pole in multiple dimensions, the x-direction, the y-direction, around the axis of rotation of the pole, or any combination of these three.

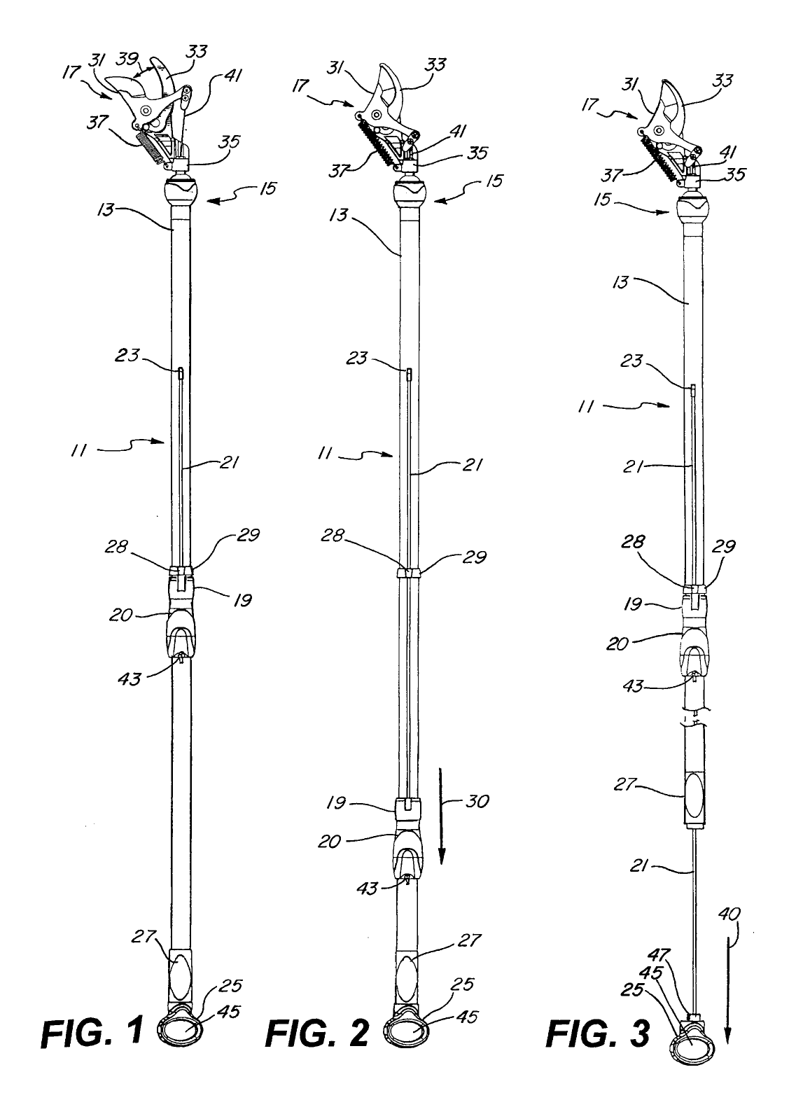

FIG. 1 illustrates the major exterior components of pruning lopper 11. A cylindrical pole 13 has two ends. At one end of the pole, an attachment mechanism 15 connects a lopping head 17 to the pole 13. A pull grip 19 located near the middle of the pole 13 connects to a cord 21. The cord 21 passes from the pull grip 19, through an aperture 23 in the pole surface to engage with an internal pulley system, as will be described hereafter. The cord 21 exits the interior of the pole 13 at the other end and attaches to a bottom pull ring 25. A bottom grip 27 is located on the end of the pole 13 opposite the lopping head end to provide a grip for a user (not shown) when the pruning lopper 11 is in operation. A stop 29 is attached to the pole 13 about midway between the ends to prevent the pull grip 19 from moving closer to the lopping head 17.

The lopping head 17 may be a bypass lopper having two blades, a movable blade 31 in combination with a fixed hook blade 33 or an anvil lopper, for example, or any other like cutting mechanism. Fixed hook blade 33 and movable blade 31 are attached to a hook holder 35. Fixed hook blade 33 is firmly fixed in position relative to the hook holder 35. Movable blade 31 can rotate relative to the hook holder 35. A spring 37 connects from the movable blade 31 to the hook holder 35 to position the blade 31 and create a gap 39 between movable blade 31 and fixed hook blade 33. A cable 41 connects the movable blade 31 to an internal pulley system that will be described hereinafter. The spring 37 and cable 41 hold the movable blade 31 in a position that maintains the gap 39 between the movable blade 31 and the fixed hook blade 33.

Lopping head 17 may also be a single blade cutting mechanism, such as a saw blade or a rotary saw device, for example, or any equivalent mechanism capable of cutting twigs and branches.

The lopping head 17 is connected to the pole 13. The pole 13 is preferably aluminum or the equivalent, having a fixed length. Alternatively, the pole may be adjusted in length as shown in FIG. 10.

The pole 13 is hollow with an oval cross-section, the two opposed flattened sides of the oval help to accommodate a user's grip and align the pull grip 19 along the pole 13. The shape of pole 13 may also be square, or triangular, for example, or any other equivalent shape that provides the desired function.

The pull grip 19 slides up and down pole 13 near the middle section of pole 13. The internal surface of the pull grip 19 substantially conforms to the shape of the pole 13. The pull grip 19 is preferably composed of glass filled nylon or the equivalent. The exterior of pull grip 19 is a flattened sleeve surrounding the exterior of the pole 13. The interior diameter of pull grip 19 is fitted to the diameter of pole 13 to provide for smooth motion along the pole 13. The flattened sides of the pole 13 and conforming interior surface of pull grip 19 prevent rotation of the pull grip 19 around the pole 13. Hand cushioning 20 on the pull grip 19 may be thermoplastic rubber or the equivalent. Movement of the pull grip 19 towards the lopping head 17 is restricted by a ring shaped stop 29. Stop 29 is fastened to the pole 13 with a rivet, or equivalent. A curved contour eyelet 28 in the side of the stop 29 allows the cord 21 to thread through the stop 29 and attach to the pull grip 19, as shown in FIG. 2.

The cord 21 preferably attaches to pull grip 19 by a knot 43 or any other equivalent manner that provides for secure attachment under the operating conditions of the pruning lopper. The cord 21 is preferably a 600 pound test polyester cord, or the equivalent. The cord 21 is pre-stretched to prevent slack during use. The cord 21 may also be a cable, chain or belt, for example, or any other equivalent structure.

The cord 21 extends from the pull grip 19 through the eyelet 28 in the stop 27 into an aperture 23 in the pole to connect to an internal pulley system described hereafter. The cord exits the pole 13 at the end opposite to the lopping head and attaches to the bottom pull ring 25.

The bottom pull ring 25 is ring-shaped. It is held to the end of the pole by the tension in the cord 21 created by spring 31 on the lopping head. The ring 25 is preferably sized to allow a user's hand or fingers to comfortably fit through the opening 45 of the pull ring 25. The pull ring 25 is preferably composed of polypropylene or equivalent. Hand cushioning located on the pull ring 25 may be thermoplastic rubber or the equivalent. The pull ring 25 has a cylindrical portion 47 attached to its side, shown in FIG. 3. This cylindrical portion fits into the interior of the pole 13 and holds the pull ring 25 in place. The cord 21 preferably attaches to the pull ring 25 through a knot (not shown), or equivalent. The pull ring 25 may also be a plug or hand grip device, for example, or equivalent mechanism capable of being grasped by hand.

A bottom grip 27 is located on the end of the pole 13 near the pull ring 25 to provide a hand grip for a user when the pruning lopper 11 is in operation. The user can grip the bottom grip 27 with one hand while gripping either the pull grip 19 or the bottom pull ring 25 with the other hand. The bottom grip 27 wraps around, and conforms to the oval shape of the pole 13. The bottom grip 27 is preferably composed of thermoplastic or equivalent.

FIG. 2 illustrates the operation of pruning lopper 11. The pruning lopper 11 is designed to allow a user (not shown) to comfortably and effectively cut tree branches and shrubs. In operation, the user slides pull grip 19 along the pole 13 in the direction 30 towards bottom grip 27. The movement of pull grip 19 tensions the cord 21, causing the internal pulley system to pull on cable 41. Cable 41 pulls on movable blade 31, which overcomes the force of spring 37. Movable blade 31 moves towards fixed hook blade 33, closing the gap 39 between the two blades 31, 33, and cutting an object (not shown) between the two blades 31, 33. After the user releases the pull grip 19, the spring 37 restores the gap 39 and the pull grip 19 slides towards the stop 29. The stop 29 prevents the spring 37 from moving the pull grip 19 further up the pole 13 towards the lopping head 17.

FIG. 3 illustrates an alternate operation of the pruning lopper 11. A user (not shown) pulls on pull ring 25 with a force in a direction 40 away from the lopping head 17. Similar to the operation illustrated in FIG. 2, the movement of bottom pull ring 25 tensions the cord 21, which operates the pulley system and thereby pulls on cable 41. When the internal pulley system is engaged, cable 41 pulls on movable blade 31, which overcomes the force offered by spring 37. Movable blade 31 moves towards fixed hook blade 33, eliminating the gap 39 between the two blades 31, 33, and the blades 31, 33 cut an object (not shown) located in the gap. After the user releases the pull ring 25, the spring 37 restores the gap 39 and pulls the bottom pull ring 25 towards the pole 13.

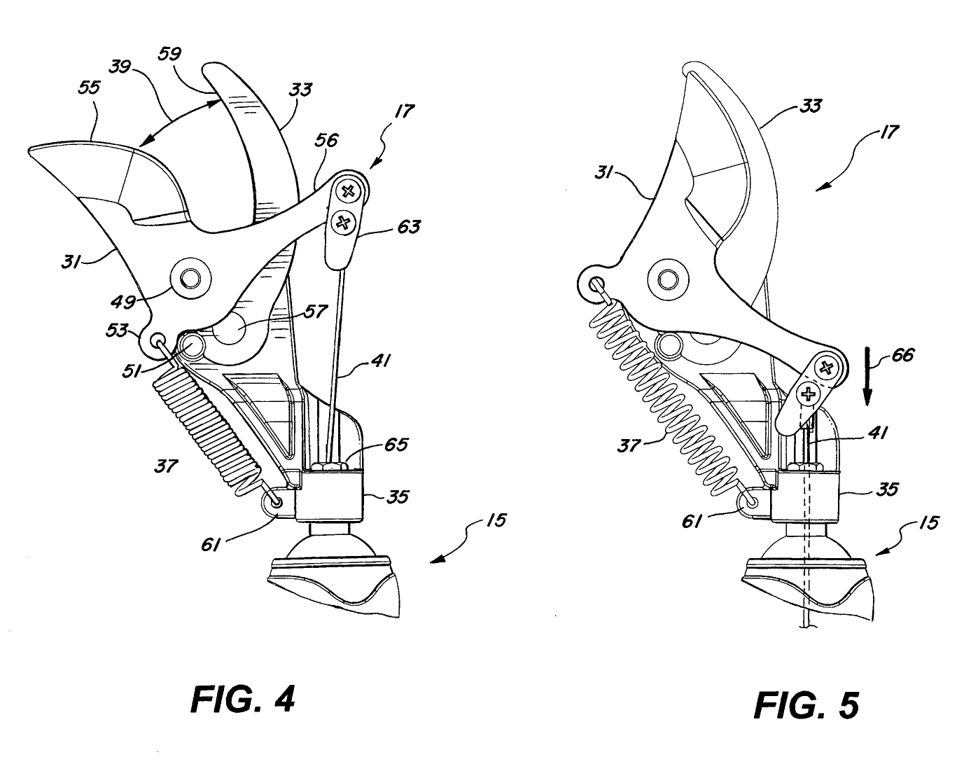

FIG. 4 illustrates the individual components of the lopping head 17. The lopping head 17 has a movable blade 31 that is attached to hook holder 35 through a pivot bolt 49. The pivot bolt 49 secures the movable blade 31 to the hook holder 35 at a fulcrum position located between a sharpened edge 55 of the movable blade 31 and an extension portion 56 of the blade 31. Pivot bolt 49 is secured in place with a nut (not shown) on the side of the hook holder 35 not shown in FIG. 4. Pivot bolt 49 serves as a rotation point for movable blade 31 when the spring 37 and cable 41 exert force on the movable blade 31. Movable blade 31 attaches to the spring 37 through a crafted loop 53. Movable blade 31 attaches to the cable 41 through the extension portion 56, which provides leverage. The rotation of movable blade 31 is further controlled by a guide-point 51, which is a crafted part of hook holder 35. The blade's sharpened edge 55 is arc-shaped, to cut the branches of trees and twigs of shrubs contemplated by the present invention. The arc-shape varies the incident surface area of the cut during operation to provide a superior cutting ability. Alternatively, the sharpened edge 55 may be any other equivalent shape suitable for cutting. Movable blade 31 preferably has a composition of SK-5 steel at 50-55 HRC with a PTFE coating or the equivalent.

The fixed hook blade 33 is form pressed into hook holder 35 to firmly fix it to the hook holder 35. Secure point 57 is a crafted part of hook holder 35 that helps to maintain the fixed hook blade 33 in the hook holder 35. The fixed hook blade 33 is substantially arc-shaped, to correspond to the arc-shape of the movable blade's sharpened edge 55. The fixed hook blade 33 has a sharpened edge 59. The sharpened edge 59 conforms to the arc-shape of the fixed hook blade. The fixed hook blade 33 is preferably composed of chrome plated steel at 40-45 HRC, or the equivalent.

Hook holder 35 is a single molded piece of material, preferably composed of glass filled nylon or the equivalent. Hook holder 35 receives and houses the movable blade 31 and the fixed hook blade 33. Hook holder 35 attaches to the spring 37 through a crafted loop 61.

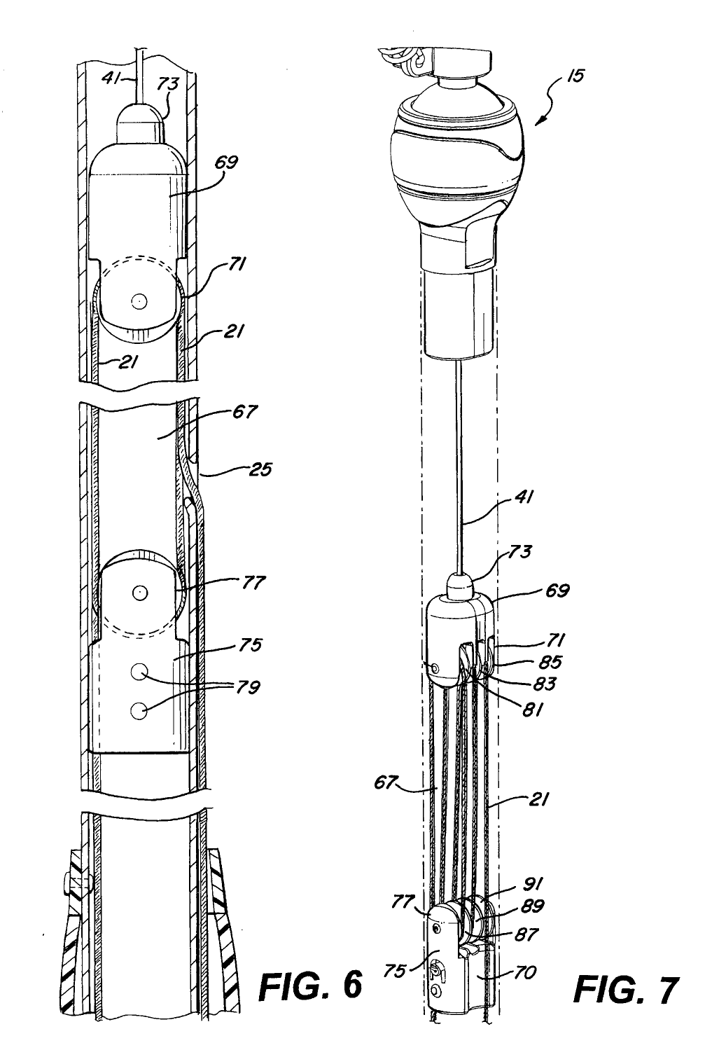

The cable 41 is fixed to movable blade 31 with a swiveling bracket 63. The swiveling bracket 63 allows the movable blade 31 to rotate without greatly altering the path of the cable 41. The cable 41 is preferably composed of 700 pound test threaded multistrand steel, or equivalent. The preferred multistrand composition of the cable 41 provides a strong connection to the movable blade 31, but also accommodates rotation of the hook holder 35 about the axis of the pole 13. The stranding prevents damage to the cable 41 over extended use. The cable 41 travels into attachment mechanism 15, guided by a cable guide 65. The cable guide 65 maintains a smooth path for the cable 41 when the lopping head 17 rotates, and threads the cable 41 through approximately the center of the attachment mechanism 15. After traveling through attachment mechanism 15, the cable 41 is fixed to the internal pulley system shown in FIGS. 6 and 7. The cable 41 may be a cord, chain, or belt, for example, or any equivalent device capable of withstanding the operating forces of the lopping head.

FIG. 5 is a perspective view of the lopping head 17 in operation. As previously illustrated in FIG. 2 and FIG. 3, when the user (not shown) pulls on either pull grip 19 or pull ring 25, the internal pulley system 67 operates and cable 41 pulls on the movable blade 31 in the direction 66. The gap 39 thereby closes. The outstretched spring 37 exerts a reciprocal force on the movable blade 31. The reciprocal force returns the system to the initial state shown in both FIG. 1 and FIG. 4 after the user releases the on pull grip 19 or pull ring 25. FIG. 5 also more clearly illustrates the threading of the cable 41 through the attachment mechanism 15 to the internal pulley system.

FIG. 6 is a cut away view of the pole 13 displaying the internal pulley system 67. The pulley system 67 comprises an upper pulley housing 69, which contains pulley wheels 71. The upper pulley housing 69 has a swivel 73 that connects to the cable 41, and allows the cable 41 to flex and rotate to correspond to the motion of the lopping head 17. The upper pulley housing 69 is shaped to substantially conform to the oval shape of the pole 13. The upper pulley housing 69 slides along the interior of the pole 13 substantially free of friction. The oval shape of the upper pulley housing 69 prevents the upper pulley housing 69 from rotating within the pole 13. The upper pulley housing 69 is preferably made of thermoplastic or the equivalent. Although the invention utilizes a pulley system 67, any equivalent mechanical leveraging system such as a gear system for example, that fits within the required space may be used.

The pulley system 67 also includes a lower pulley housing 75, which contains pulley wheels 77. Unlike the upper pulley housing 69, lower pulley housing 75 is fixed to the pole 13 by an anchor 79. The anchor 79 physically extends from the housing 75 through the surface of the pole 13 to mechanically fix the pulley housing 75 to the pole 13. The lower pulley housing 75 is shaped to substantially conform to the oval shape of the pole 13, but also includes grooves 70, visible in FIG. 7, that allow the cord 21 to pass through the system 67. The lower pulley housing 75 is preferably made of thermoplastic or the equivalent.

The cord 21 wraps between the upper pulley wheels 71 and lower pulley wheels 77. One end of the cord 21 is threaded through the pulley wheels 71, 77 and exits the pole 13 at the aperture 23 where it is secured to the pull grip 19. The other end of the cord 21 threads through the pulley wheels 71, 77 and remains inside the pole 13 until it exits at the end and attaches to pull ring 25.

FIG. 7 is a perspective view of a preferred embodiment of the pulley system 67. FIG. 7 illustrates the path of the cord 21 through the upper 71 and lower 77 pulley wheels. In the preferred embodiment, the upper pulley wheels 71 comprise three wheels: a first upper wheel 81; a second upper wheel 83; and a third upper wheel 85. The lower pulley wheels 77 comprise three wheels: a first lower wheel 87; a second lower wheel 89; and a third lower wheel 91. All the wheels 81, 83, 85, 87, 89, 91 are of approximately equal size. The cord 21 travels from the pull ring 25 and passes over the first upper wheel 81. The cord 21 then threads in sequence under the first lower wheel 87, over the second upper wheel 83, under the second lower wheel 89, and over the third upper wheel 85. The third lower wheel 91 acts to guide the cord to pass through the aperture 23 in the pole and connects to the pull grip 19 on the outside of the pole. The multiple passes of the cord 21 through the wheels 71, 77 create an ideal mechanical advantage multiple of six for the force applied by a user. In addition, the symmetry of the pulley system 67 provides a nearly equal mechanical advantage if the user alternatively applies force to the pull grip 19 or pull ring 25. Alternatively, the number of pulleys utilized may be varied to increase or decrease the mechanical advantage of the system.

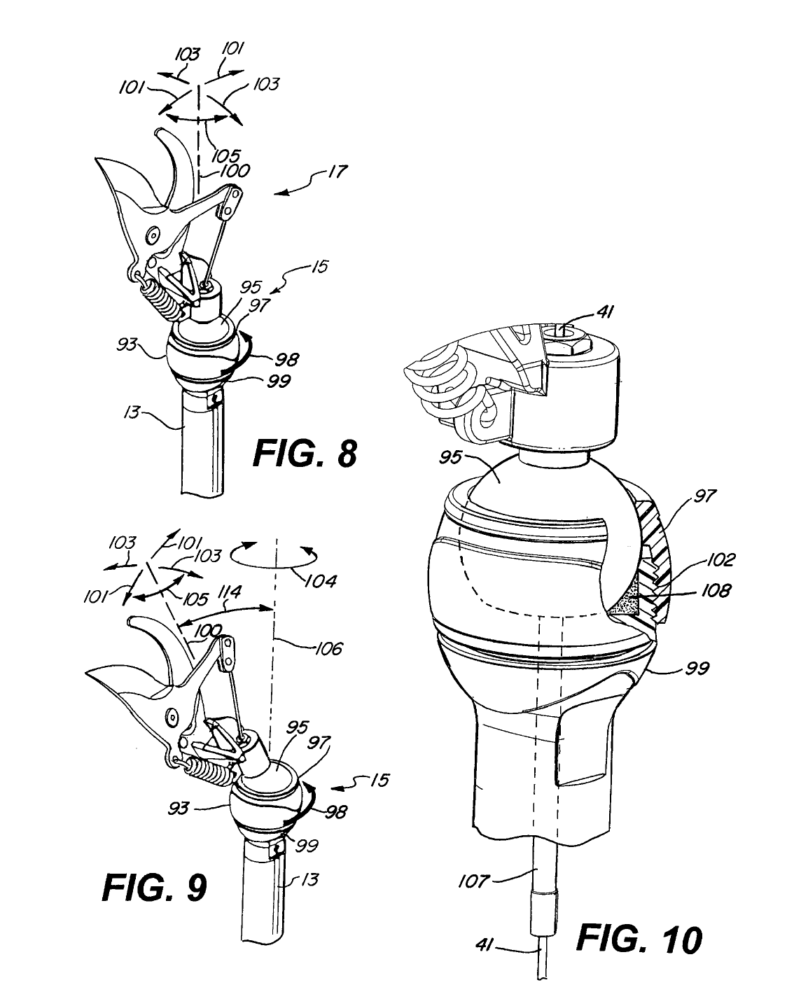

FIG. 8 is a perspective view of the preferred embodiment of attachment mechanism 15. Attachment mechanism 15 is a ball joint 93. The ball joint 93 has a ball 95, a ball joint cap 97, and a ball joint base 99. The lopping head 17 is attached to the ball 95 at the axis of rotation 100 of ball 95. The position of the ball 95 can change relative to the pole 13, which correspondingly changes the position of the attached lopping head 17 with respect to the axis of rotation of the pole. The ball joint 93 allows the user to move the lopping head 17 in three degrees of freedom. These degrees of freedom include motion in the x-direction 101, the y-direction 103, and a rotation 105 around the ball 95 axis 100. The position of ball 95 can be determined by any combination of movement along the three degrees of freedom 101, 103, 105. The user controls the position of ball 95 by fixing the ball in the desired position by the pressure applied by the ball joint cap 97. The user manually tightens the ball joint cap 97 over the ball joint base 99 by threading the cap 97 down on the base 99 to tightly grip the ball 95. Tightening the ball joint cap 97 locks the ball 95 in position. The user can vary the position of the ball by loosening the ball joint cap 97 in the direction 98, moving the ball 95, and then re-tightening the cap 97 in the direction opposite to 98. The attachment mechanism 15 may also be any other mechanical device that allows for rotation of the lopping head 17 in at least two, or three degrees of freedom, such as a swivel, a clamp, a gimbal, a gear system, or a disc system, for example, or any equivalent.

FIG. 9 illustrates the increased range of cutting angles available when the ball 95 axis 100 is displaced 114 from the axis of rotation 106 of the pole. The lopping head can rotate 104 around the axis 106 of the pole. In addition, the lopping head 17 can rotate around the axis 100 of the ball 95 when the ball 95 is displaced from the axis 106 of the pole to cut tree branches at various angles.

FIG. 10 is a more detailed illustration of the attachment mechanism 15. FIG. 10 illustrates the relation between the ball 95, the ball joint cap 97, the ball joint base 99, and the threads 102 between the ball joint cap 97 and base 99. A rubber friction ring 108 is located between the ball joint base 99 and the ball 95. The ball 95 is secured in place because of the pressure and friction applied to the ball 95 by ball joint cap 97 and rubber friction ring 108. The threads 102 provide a secure mechanical connection between the cap 97 and base 99. The ball 95, ball joint cap 97, and ball joint base 99 are all made of glass filled nylon or the equivalent.

FIG. 10 also illustrates a cable sleeve 107 that guides the cable 41 through the center of the ball 95. The cable 41 enters the ball 95 at an angle perpendicular to the surface of the ball 95 even when the ball 95 changes position.

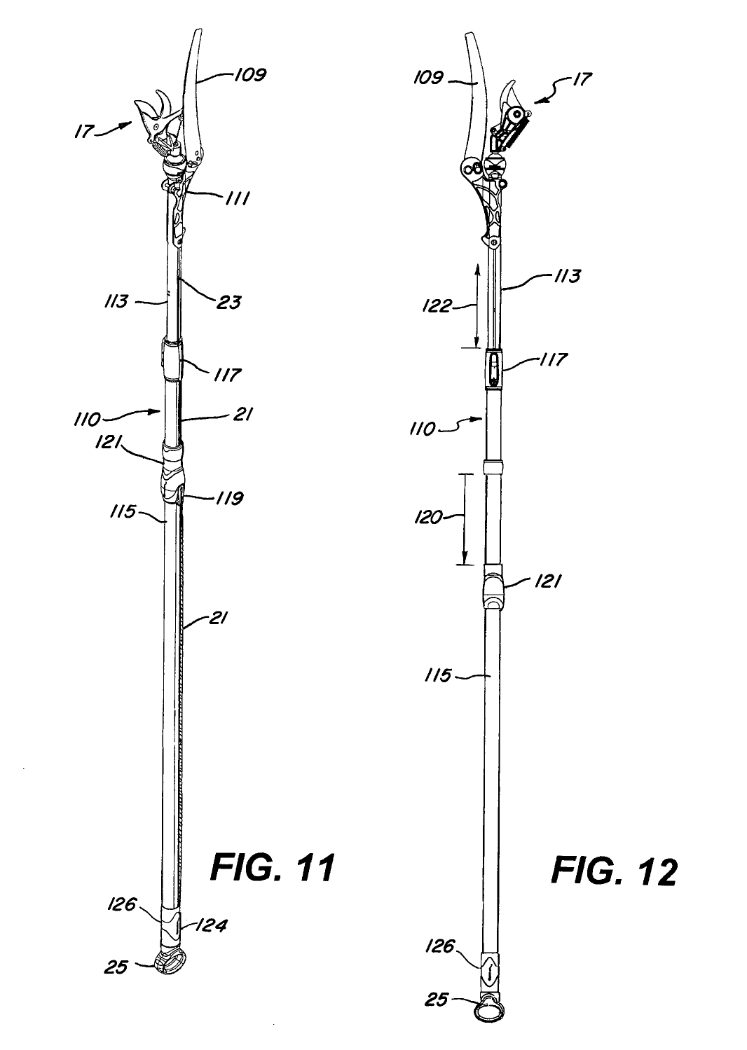

FIG. 11 is a perspective view of an alternative embodiment 110 of the pruning lopper. The pruning lopper 110 includes a saw 109 and saw mount 111 attached to the end of the pole carrying the lopping head. The saw 109 allows a user (not shown) to saw thick branches too large or stiff for the lopping head 17 to cut. The saw 109 is firmly fixed to the pole 13 with a friction grip provided by saw mount 111 that clamps along the upper end of pole 113.

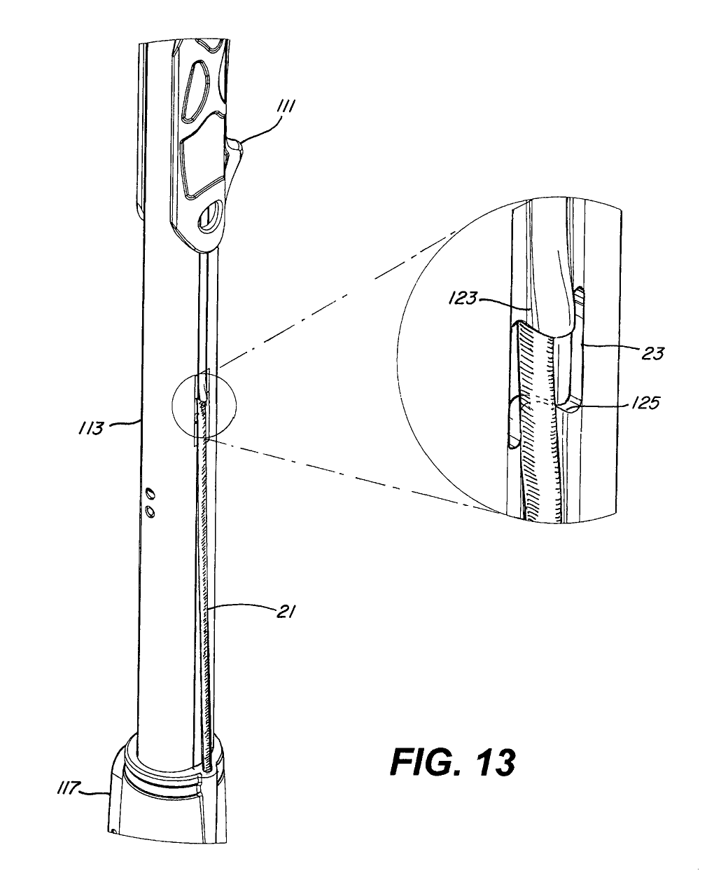

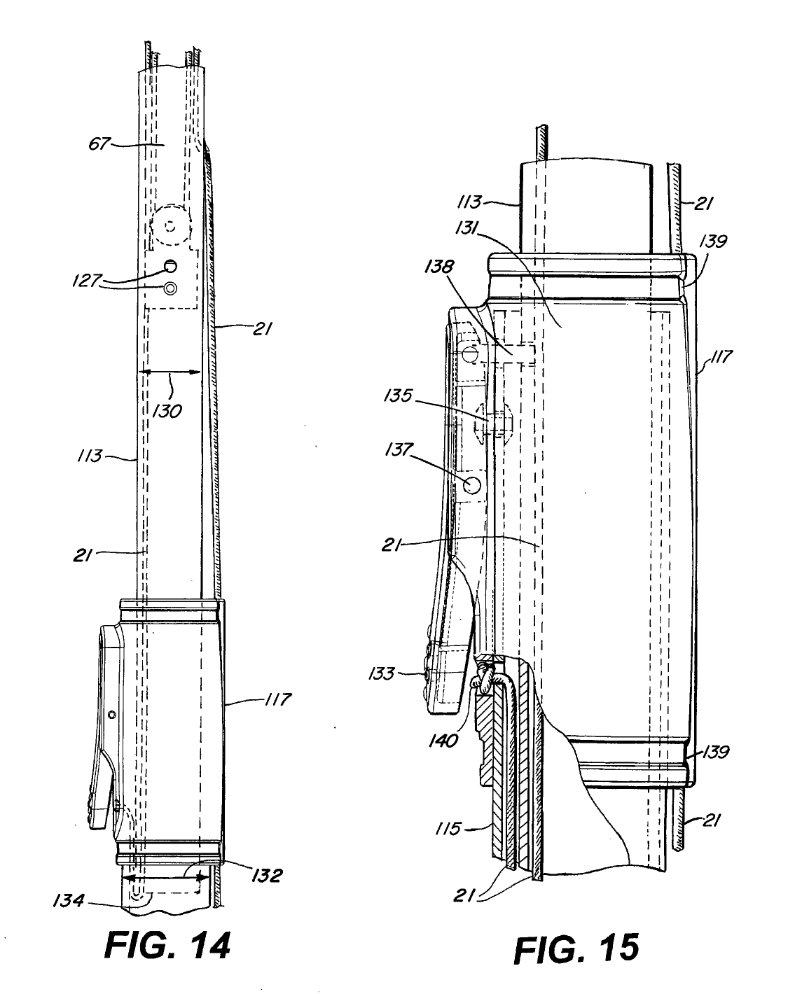

The pruning lopper 110 of FIG. 11 also is extendable by having two mechanically distinct poles 113, 115. An upper telescoping pole 113 slides into a pole housing 115. The combination increases the length of the pruning lopper 110. The telescoping pole 113 slides out from the pole housing 115. The position of the telescoping pole 113 is controlled by an extension mechanism 117 more fully illustrated in FIGS. 13 and 14. The telescoping pole 113 is preferably made of aluminum or the equivalent light metal, and the pole housing 115 is preferably made of fiberglass or the equivalent.

One end of the cord 21 exits an aperture 23 in the telescoping pole 113 toward the extension mechanism 117. The cord 21 passes through a sleeve in extension mechanism 117 and attaches to a cleat 119 located on a pull grip 121. The cord 21 passes from the cleat 119 through a sleeve 124 in bottom grip 126 and attaches to the pull ring 25. A user can operate the pruning lopper by either pulling on the pull grip 121 or the pull ring 25.

The cleat 119 on the pull grip 121 locks the cord 21 in place with a ridged v-shape. A user manually presses the cord 21 into the cleat 119 to lock it in place. The v-shape offers enough strength to support the force of operation, yet also lets the user easily disengage the cord 21 from the cleat 119. The cleat 119 allows a user to readjust the position of the pull grip 121 by lifting the cord 21, sliding the pull grip 121 into a desired position, and then locking the cord 21 back down. A user will adjust the pull grip 121 to suit the various grips he chooses along the pole housing 115.

The other end of the cord 21 still inside the telescoping pole 113 passes through the pulley system and travels along the inside of telescoping pole 113 in the direction toward the pull ring 25. The cord then loops over the lower edge 134 of upper telescoping pole 113, shown in FIG. 14, and travels along the exterior of upper telescoping pole 113 towards the attachment mechanism 118. The lower edge 134 may have a plastic adaptor, eyelet, or bearing surface that allows the cord 21 to smoothly slide over the lower edge 134. The cord threads between the exterior of upper telescoping pole 113 and the interior of the pole housing 115. The cord 21 fixes to a secure point on the attachment mechanism 117, as shown in FIG. 15. Looping the cord over the pole 113 keeps a constant length of cord 21 in the pulley system 67 when the telescoping pole 113 is extended or retracted in the pole housing 115.

FIG. 12 shows the operation of the pruning lopper 110. As in FIG. 2, the user pulls in the direction 120 on pull grip 19 to operate lopping head 17. The user may also pull on the pull ring 25 to operate the lopping head 17. The telescoping pole 113 may be extended by a distance 122 to a fixed length, controlled by the extension mechanism 117.

FIG. 13 shows a detail of aperture 23. The aperture 23 has a shaped exit from the telescoping pole 113 to allow the cord 21 to exit the telescoping pole 113 with minimal friction. As shown in the greatly expanded view of this section of the telescoping pole 113, the upper end of the aperture 123 is curved outward to allow the cord 21 to exit smoothly. The lower end of the aperture 125 is curved inward. The curved aperture may also be utilized in the embodiment initially displayed in FIG. 1.

FIG. 14 is a detailed view of the telescoping pole 113, the pulley system 67, and the extension mechanism 117. The telescoping pole 113 has a smaller external diameter 130 than the internal diameter 132 of pole housing 115. When the telescoping pole 113 is extended, the pulley system 67 travels with the telescoping pole 113 because is it anchored by an anchor point 127. The cord 21 is shown traveling down towards the pull ring 25 along the interior of telescoping pole 113, over the lower edge 134, and up towards the attachment mechanism 117 along the exterior of telescoping pole 113.

FIG. 15 is a detailed view of the extension mechanism 117. Extension mechanism 117 has a collet housing 131, a collet button 133, a rivet 135, a collet pivot 137, a collet pin 138, and secure point 140. The cord 21 fixes to the secure point 140 with a knot or the equivalent. The collet pivot 137 fixes the collet button 133 to the collet housing 131. The collet pin 138 is attached to the collet button 133. The rivet 135 fixes the collet housing 131 to the pole housing 115. The collet housing 131 provides a sleeve 139 for the cord 21 to pass through to the pull grip 121. The collet housing 131 is preferably composed of glass filled nylon or the like. When the user presses on the collet button 133, the button 133 pivots on the collet pivot 137, displacing the collet pin 138. The collet pin 138 rests within a hole (not shown) located along telescoping pole 113. The telescoping pole 113 has a plurality of holes (not shown) to allow the pin 138 to enter the pole 113 at any of those holes. A spring (not shown) presses against the collet button 133 to keep the collet pin 138 secured to the telescoping pole 113.

What is claimed is:

1. A pruning lopper comprising:
a pole having a first end and a second end and an axis of rotation;
a lopping head located at the second end of the pole; and
an attachment mechanism attaching the lopping head to the second end of the pole, so that the lopping head is capable of rotating in at least two degrees of freedom relative to the axis of rotation of the pole.

2. The pruning lopper of claim 1, wherein the attachment mechanism is capable of rotating in three degrees of freedom relative to the axis of rotation of the pole.

3. The pruning lopper of claim 1, wherein the attachment mechanism comprises a ball joint.

4. The pruning lopper of claim 1, further comprising a leveraging system located substantially within the interior of the pole.

5. The pruning lopper system of claim 4, wherein the leveraging system is a pulley system comprising:
a fixed pulley block;
a movable pulley block; and
a cord with a first end and a second end, the cord connecting the fixed pulley block to the movable pulley block.

6. The pruning lopper of claim 5, wherein the first end of the cord is secured to a first fixed point located on the exterior of the pole and the second end of the cord is secured to a second fixed point located at the first end of the pole.

7. The pruning lopper of claim 6, wherein the second fixed point is on a pull ring detachable from the pole.

8. The pruning lopper of claim 6, wherein the first fixed point is located on a pull grip that slides along the pole.

9. The pruning lopper of claim 4, wherein the lopping head comprises a fixed blade and a movable blade.

10. The pruning lopper of claim 9, further comprising a cable with a first end and a second end, the first end attached to the movable blade and the second end attached to the leveraging system located within the pole.

11. The pruning lopper of claim 10, wherein the attachment mechanism comprises a ball joint, and the cable passes through the ball of the ball joint at an angle substantially perpendicular to the surface of the ball.

12. A pruning lopper comprising:
a pole housing having a first end and a second end;
a telescoping pole having a first end and a second end and an axis of rotation, wherein the first end of the telescoping pole is located within the pole housing at the second end of the pole housing;
a lopping head located at the second end of the telescoping pole; and
an attachment mechanism attaching the lopping head to the second end of the telescoping pole, so that the lopping head is capable of rotating in at least two degrees of freedom relative to the axis of rotation of the telescoping pole.

13. The pruning lopper of claim 12, wherein the attachment mechanism is capable of rotating in three degrees of freedom relative to the axis of rotation of the telescoping pole.

14. The pruning lopper of claim 12, wherein the attachment mechanism comprises a ball joint.

15. The pruning lopper of claim 12, further comprising a pulley system located substantially within the interior of the telescoping pole, comprising:
a fixed pulley block;
a movable pulley block; and
a cord with a first end and a second end, the cord connecting the fixed pulley block to the movable pulley block.

16. The pruning lopper of claim 15, wherein the first end of the cord exits the upper telescoping pole and secures to a fixed point located at the first end of the pole housing.

17. The pruning lopper of claim 16, further comprising a pull grip that slides along the exterior of the pole housing, the pull grip having a cleat that connects the pull grip to the cord.

18. The pruning lopper of claim 15, wherein the lopping head comprises a fixed blade and a movable blade.

19. The pruning lopper of claim 18, further comprising a cable with a first end and a second end, the first end attached to the movable blade and the second end attached to the pulley system within the telescoping pole.

20. The pruning lopper of claim 18, wherein the attachment mechanism comprises a ball joint, and the cable passes through the ball of the ball joint at an angle substantially perpendicular to the surface of the ball.
